(19) United States
(12) Patent Application Publication
(10) Pub. No.: US 2026/0177249 A1
(43) Pub. Date: Jun. 25, 2026

(54) KITCHEN EXTRACTOR HOOD AND COOKING SYSTEM

(71) Applicant: FABER S.p.A., Fabriano (IT)

(72) Inventor: Alberto Gasparini, Fabriano (IT)

(73) Assignee: FABER S.p.A., Fabriano (IT)

(21) Appl. No.: 19/123,166

(22) PCT Filed: Oct. 30, 2023
(86) PCT No.: PCT/EP2023/080244

§ 371 Date: Apr. 22, 2025

(30) Foreign Application Priority Data
Nov. 4, 2022 (EP) 22205568.3

(51) Int. Cl. F24C 15/20; F24C 15/10; F24C 15/14

(52) U.S. Cl. CPC F24C 15/2042; F24C 15/10; F24C 15/14

(57) ABSTRACT

A kitchen extractor hood having: a body for positioning at a wall, the body having inlet and outlet portions, a fan arranged for sucking in cooking fumes, in particular from a cooking hob, above which the extractor hood is positioned, via the inlet portion, and for pushing these fumes through the outlet portion out of the extractor hood. The body has a box-shaped portion extending beyond the inlet portion. This, box-shaped portion supports a retractable cooking device having heating element(s) capable of assuming a first position below the inlet portion during use for food preparation, in which first position the cooking device is folded out of the box-shaped portion, and a second position, in which the cooking device is folded back into the box-shaped portion when not in use. The cooking device, when folded out, is placed spaced between 25 and 35 cm from the inlet portion.

### CROSS-REFERENCE TO RELATED APPLICATIONS

This application is a 371 National Phase of International Application No. PCT/EP2023/080244, filed Oct. 30, 2023, which claims priority from European Patent Application No. 22205568.3, filed Nov. 4, 2022, both of which are incur[orated herein by reference as if fully set forth.

### TECHNICAL FIELD

The invention relates to an extractor hood and to a cooking system, which cooking system comprises a cooking hob in addition to the extractor hood.

### BACKGROUND

Nowadays, kitchens are regularly equipped with cooking hobs (operated with electricity and/or gas), which cooking hobs are often integrated into a kitchen worktop.

An extractor hood is regularly arranged above such cooking hobs in order to extract vapours or smoke produced during cooking or frying. This exhaust air can then be transported to the outside or filtered and then returned to the kitchen.

In order to be able to prepare additional types of food and dishes, there is often a need for an additional cooking device in the kitchen, which can be designed either as a barbecue grill and/or as a plancha, hotstone or the like, as required. However, such cooking devices are not needed all the time, but only occasionally, so that there is a corresponding need for such cooking devices that are not present all the time, so that they do not take up unnecessary space or get dirty.

Cooking devices are already known from the prior art that can be swivelled between a folded-out operating position and a folded-in storage position.

Furthermore, such additional cooking devices often produce an increased level of fumes, especially smoke, during operation, especially when said cooking devices are a devised in the form of a barbecue grill.

There is therefore an additional need for such an additional cooking device, the exhaust air from which can be extracted and removed as efficiently as possible.

### SUMMARY

The invention is therefore based on the task of further developing an extractor hood of the type mentioned above in such a way that the exhaust air produced when using the cooking device, in particular vapours and/or smoke, can be extracted and removed as efficiently as possible.

This object is achieved in a kitchen extractor hood having one or more of the features disclosed herein.

Where a cooking system according to the invention is concerned, the object is achieved by one or more of the features disclosed herein.

Advantageous further developments are defined in the description and claims that follow.

According to the invention, a kitchen extractor hood comprises: a body for positioning at a wall of the kitchen, said body having an inlet portion and an outlet portion, a fan arranged in said body for sucking in cooking fumes and vapours, in particular from a cooking hob of the kitchen, above which cooking hob the extractor hood is to be positioned, via said inlet portion and for pushing said fumes and vapours through the outlet portion out of the extractor hood, the body of the extractor hood has a box-shaped portion extending beyond the inlet portion and preferably along said wall of the kitchen, said box-shaped portion supporting a retractable cooking device having heating means capable of assuming a first position below said inlet portion during use for the preparation of food by said heating means, in which first position the cooking device is folded out of said box-shaped portion, and a second position, in which second position said cooking device is folded back into said box-shaped portion when not in use. The extractor hood is further characterised in that said cooking device, when folded out, is placed at a distance between 25 and 35 cm from the inlet portion, preferably at a distance of about 30 cm.

According to another aspect of the invention, a cooking system comprises: a kitchen extractor hood according to the present invention and an additional cooking hob, wherein the extractor hood is placed above said cooking hob and wherein preferably the cooking device, in its first position, is located at a free distance from, i.e., above, said cooking hob, said free distance measuring between 10 and 30 cm, preferably 20 cm.

Normally, conventional extractor hoods are located at a distance of about 60 cm above a cooking hob (said hob being integrated in a kitchen worktop). Such a distance can be too great, in particular, when a lot of smoke is produced during the preparation of food, as is the case, for example, when frying or grilling. In this case, the conventional extractor hood is often not able to remove the existing exhaust air to a sufficient extent. Due to the fact that, according to the invention, the cooking device in the unfolded state is only about 30 cm below the inlet area or inlet portion of the actual extractor hood, this problem can be safely avoided.

This also applies to the cooking system according to the invention, because the fold-out cooking device does not rest on the additional cooking hob, but is located at a clear distance above it. It forms an additional cooking level, so to speak, which is arranged above the normal cooking level.

Both the cooking hob and the fold-out cooking device can, in principle, be used simultaneously. In particular, it may be possible to use two pans with a limited height of about 5 cm max on the (two) front hob heaters while the fold-out cooking device is in operation.

According to a further development of the extractor hood according to the invention, it is provided that said cooking device comprises a plancha, a hotstone and/or a barbecue grill, e.g., in the form of a cast iron cooking plate. Said plancha can take the form of a stainless-steel plate (teppan yaki). Said hotstone can take the form of a soapstone. Within the scope of the present invention, it is further possible to combine different cooking zones and different materials in one cooking device. Said cooking elements (plancha, hotstone, cast-iron plate, etc.) may be removable, e.g., for cleaning, and/or interchangeable.

Such cooking devices are often not present in a conventional kitchen. They are also characterised by an increased generation of steam or smoke and are therefore predestined for use within the scope of the present invention.

According to a further development of the extractor hood according to the invention, it is provided that said cooking device comprises a casing, in which casing at least said heating means are located, which casing preferably comprises a thermal insulation and/or is made—at least in part—from a thermally insulating material, e.g., ceramic fibre.

Such an enclosure or casing helps to prevent the cooking device from becoming too hot on the outside in order to protect a user during use.

Said heating means can be devised in a number of alternative ways. For instance, alternatives to the usual tubular heating elements indicated as a main solution for the barbecue can include infrared or halogen heating elements under glass-ceramic (same solution as preferably assumed for any upper additional heater inserted in the perimetral panel of the hood, cf. further embodiment described further down).

According to a further development of the extractor hood according to the invention, it is provided that said casing, i.e., an interior thereof, is in fluidic connection with said inlet portion.

Such a fluid connection enables active cooling of the cooking device by utilising a fan already present in the extractor hood, which is synergistically particularly efficient and cost-effective.

According to a further development of the extractor hood according to the invention, it is provided that said fluidic connection is provided by and passes through said box-shaped portion.

In this way, the mechanical structure in the extractor hood can be used for said cooling in a particularly favourable and space-saving manner.

According to a further development of the extractor hood according to the invention, it is provided that an interior of said casing is fluidically connected with said inlet portion in an area below said heating means.

In this way, effective cooling of the cooking device can be provided without adversely affecting a heating effect of said heating means.

According to a further development of the extractor hood according to the invention, it is provided that said casing has at least one air intake opening, preferably in a portion below said heating means, more preferably on a front side facing away from said body in said first position and/or on a lateral side thereof.

Fresh air can be introduced into the cooking device from the outside through said opening in order to make the intended cooling effect as efficient as possible.

According to a further development of the extractor hood according to the invention, it is provided that said body comprises at least one additional fan, which fan is arranged to take in air from outside the extractor hood and to push said air into said casing, preferably in an area below said heating means.

Such an embodiment offers an additional or alternative cooling possibility for the cooking device, which does not use an existing fan of the extractor hood, but an additional fan, which can offer the advantage that the cooling effect can also be ensured or controlled independently of a further function of the extractor hood.

According to a further development of the extractor hood according to the invention, it is provided that said casing has at least one air outlet opening, preferably in a portion below said heating means, more preferably on a front side facing away from said body in said first position and/or on a lateral side thereof.

In this case, the air flow can be just the opposite of the above-mentioned embodiment: whereas in the above-mentioned embodiment air was drawn into the housing from the outside, air provided by the additional fan can now be expelled from the housing. It is, however, also possible to draw outside cooling air into the casing by means of said additional fan.

According to a further development of the extractor hood according to the invention, it is provided that said box-shaped portion has a recess for engaging with the cooking device in said second or storage position and at least one lateral portion delimiting said recess, said lateral portion preferably housing said additional fan mentioned above.

Such a recess allows the cooking device to be stowed in the folded position, which may be advantageous not only from an aesthetic point of view. The at least one lateral area delimiting the recess can be used to accommodate the additional fan in a space-saving manner.

According to a further development of the extractor hood according to the invention, it is provided that said lateral portion has at least one air intake opening for supplying air to said additional fan and is fluidically connected to an interior of said casing. Said air intake opening may be directed toward said recess so that it is covered and protected when the cooking device is folded in.

The lateral region may thus have a further function of guiding air to the additional fan and further towards the casing of the cooking device.

According to a further development of the extractor hood according to the invention, it is provided that a grease collecting channel is arranged around said plancha or barbecue grill, said grease collecting channel preferably being slanted, at least at the lateral sides of the cooking device, toward a front side of the cooking device, said front side facing away from said body (or the kitchen wall) in said first position. Said grease collecting channel can also be slanted at said front side toward a corner (or the centre) of said front side in order to guide the grease toward said corner (or centre). Said grease collecting channel more preferably further has at least one fluid connection with an outside of the extractor hood for evacuation of grease.

Because, in particular during grilling or frying, larger quantities of fat or grease are produced, such a design is particularly advantageous because it helps to keep the actual cooking device clean, which can be further supported by the aforementioned slanted design.

Through said optional fluid connection with an environment of the extractor hood, the removal of even larger quantities of grease can be ensured without these remaining in the cooking device and permanently soiling it or making costly cleaning necessary.

According to a further development of the extractor hood according to the invention, it is provided that said fluid connection is located at a front side of the cooking device in said first position, preferably in a central position or at a corner.

Corresponding tests of the applicant have shown that such an arrangement is particularly favourable in operation.

In another highly preferred embodiment, the extractor hood according to the present invention further comprises at least one temperature sensor, preferably infrared temperature sensor, more preferably integrated in an area of said inlet portion, said temperature sensor being in operative connection with said cooking device, in particular with a temperature control unit and/or with a temperature display of said cooking device for controlling and/or displaying, respectively, a cooking temperature.

Such an embodiment can further be used to generate respective cooking profiles for a plurality of recipes, using for example (meat) probes to be inserted in the foodstuff to be prepared in order to monitor a core temperature during cooking. Said probes can interact (communicate) with the cooking device to achieve a temperature control thereof.

More specifically, a wireless connection of said probes with a processor unit of the cooking device would allow the latter to manage different cooking profiles by way switching (on/off) of the heating elements via suitable control electronics. The core temperatures read by the probes could be displayed either directly on a display located on the probe or on a display located on the barbecue control area, i.e., a display on the cooking device.

In the case of infrared sensors, they can preferably provide a precise measurement of the surface temperature of the cooking plate, i.e., a cooking area of the the cooking device, and interact with said electronics to manage operation of the heating elements thus ensuring that the temperature is set for different cooking depending on of the type of food to be cooked.

The latter two approaches preferably require (and comprise) an electronic temperature control excluding the use of electromechanical thermostats.

In another highly preferred embodiment, the extractor hood according to the present invention further comprises at least additional heating element, in particular infrared heating element under glass ceramic, in an area of said inlet portion, above and preferably parallel to said cooking device in its first position, to allow a simultaneous cooking from above as well as from below, which can significantly reduce cooking time.

Said additional heating element can advantageously devised so that it can be lowered in the direction of the cooking device, either manually or by including suitable motor and operating means. In this way, cooking time can be further reduced. After cooking, the additional heating element can be moved up again and stowed in the extractor hood.

A further development of the cooking system according to the invention provides a control unit devised to enable activation of the cooking device in said first position only and to allow activation of the cooking device and said additional cooking hob separately only, wherein preferably the control unit allows activation of the cooking device only in combination with activation of the extractor hood, i.e., said fan and/or in combination with said additional fan.

In a preferred embodiment, operation of the cooking device always provides for the activation of the fan of the hood at a speed adequate to ensure proper disposal of fumes. If present, any additional cooling fan should also always preferably be activated when using the cooking device in order to prevent overheating of touchable parts.

In this way it can be ensured that the cooking device and the additional cooking hob are not accidentally operated simultaneously, which could in particular lead to injuries to the user. Furthermore, it can be ensured in this way that the cooking device can only be operated when the actual extractor hood is in operation. This can be particularly advantageous if the extractor hood's fan also provides cooling for the cooking device. The corresponding applies if the extractor hood is equipped with an additional fan for cooling the cooking device. Correspondingly, both fans should then be in operation in order to be able to use the cooking device.

In another highly preferred embodiment, the extractor hood according to the present invention further comprises a temperature sensor (e.g., as defined above) and/or a humidity sensor, which automatically turns (or turn) on the hood at a defined fan speed at the moment when, during cooking, the sensor/s detect/s a temperature between 30° C. and 40° C. and/or a humidity level around 70% in order to optimize the capture of fumes or vapors that are generated at the first moments of cooking.

In another highly preferred embodiment, the extractor hood according to the present invention further comprises a lighting system (e.g., in the form of an LED light bar), which can be arranged at the top of the rear panel of the barbecue to optimize the lighting of the cooking area.

In another highly preferred embodiment, the extractor hood according to the present invention further comprises, in connection with the foldable cooking device, a cooking zone that has been created by means of at least two (or more) cast iron plates that are preferably placed side by side in order to enable the possibility of cooking food at different temperatures in the corresponding (e.g., right and left) areas of the cooking zone, provided that the cooking device includes two (or more) heating elements with different adjustable temperatures.

Having two or more plates also achieves easier handling for the user in the case of disassembly and cleaning.

In another highly preferred embodiment, the extractor hood according to the present invention comprises a different division of the the cooling air path in order to reduce the temperature of the area of the rear vertical panel of the barbecue (i.e., the foldable cooking device) in case the user closes the barbecue just after having finished cooking with the cooking plates still very hot. In this context, the extractor hood may comprise, in said body, at least one (preferably two) additional fan/s, which fan/s is/are arranged to take in air from outside the extractor hood and to push said air along an air flow path on an outside (underside) of said casing, i.e., of said cooking device, in particular in a folded-out state thereof.

In another further development of the extractor hood, said box-shaped portion can comprise a lower fixed part of said body which includes a cover element located below the foldable cooking device, said cover element preferably being inclined with respect to said wall of the kitchen. The additional fan/s can then be located behind said cover element, and a space delimited by said cover element and by additional side cover elements has at least one air intake opening, preferably in one of said side cover elements, for supplying air to said additional fan/s and opens toward said air flow path along the outside (underside) of said casing.

Additionally, the air flow provided by said additional fan/s can divided, by means of a corresponding air flow divider located at said fan/s, into an air flow (first air flow) that is oriented toward said air flow path along the outside (underside) of said casing—or through the casing, as stated before—and into another air flow (second air flow) that is guided between a double rear wall in the box-shaped region or the receptacle for the cooking device, i.e., in an intermediate space that is formed between the two rear walls. At least the second air flow can be present even if the cooking device is folded in, so that a cooling effect results if the user closes the barbecue just after having finished cooking with the cooking plates still very hot.

In another further development of the extractor hood, a locking system has been integrated to prevent the barbecue (i.e., the foldable cooking device) from closing, which locking system can be located in a hinge area cover panel.

Said locking system can preferably be operated manually by the user, and it prevents an involuntary closure of the barbecue from the working position (folded out) when the user removes the cooking plates to clean them. It is devised to prevent a recall action of the hinges (which normally include suitable springs) that tends to close the barbecue due to the weight reduction generated by the removal of the cooking plates.

Said locking system may comprise at least one protruding structure (e.g., a pin) on an upper side of the cooking device (in a folded-out state thereof). A hinge cover part of the extractor hood, which hinge cover part is devised to be in continuous contact with said upper side of the cooking device, e.g. for to cover a area between a rear portion of the cooking device and said box-shaped portion or the receptacle for the cooking device (e.g., to prevent items from falling into said area and blocking the folding mechanism), may comprise a movable locking structure that interacts with said protruding structure. The locking structure may comprise an opening (e.g., a cut-out) and is moveable between a first position, in which the protruding structure can pass through said opening when folding the cooking device in or out, and a second position, in which the protruding structure cannot pass through said opening. Thus, by moving the locking structure once the cooking device is folded out, one can block the cooking device in its folded-out position, and it cannot fold in when the weight of the cooking plates is removed.

Said locking system may be present on only one side of the cooking device. Preferably, however, there is a locking system on each side of the cooking device.

In yet another embodiment, the extractor hood further comprises a plurality of cooking plates, each cooking plate having a hole in fluid connection with a channel piece that extends all the way through the cooking device and opens at an underside thereof, wherein the cooking device, preferably said casing thereof, has a lower extension for holding a tapering removable grease tray that has an upper opening which is located underneath said channel piece, when the grease tray is correctly inserted in said extension.

This provides for a good evacuation of greases from cooking and an easy cleaning of the device.

### BRIEF DESCRIPTION OF THE DRAWINGS

Further features and advantages of the invention will become apparent from the following description of embodiments with reference to the drawings.

FIG. 1 shows a perspective view of an extractor hood according to the invention in the second position;

FIG. 2 shows the extractor hood FIG. 1 in the first position together with an additional cooking hob;

FIG. 3 shows a perspective view of a further extractor hood according to the invention in the second position;

FIG. 4 shows the extractor hood of FIG. 3 in the first position together with an additional cooking hob;

FIG. 5 shows an exploded view of the cooking device of an extractor hood according to the invention;

FIG. 6 shows selected components of the cooking device according to FIG. 5;

FIG. 7 shows further selected components of the cooking device according to FIG. 5;

FIG. 8 shows a sectional view of the extractor hood according to FIG. 4;

FIG. 9 shows a detailed representation of the extractor hood according to FIG. 8;

FIG. 10 shows an alternative design of components of an extractor hood according to the invention;

FIG. 11 shows a detail of the design according to FIG. 10;

FIG. 12 shows a further detail of the design according to FIG. 10, partly in section;

FIG. 13 shows further details of the design according to FIG. 10;

FIG. 14 shows further details of an extractor hood according to the invention, partly in section;

FIG. 15 shows a detail from FIG. 14 in an enlarged representation.

FIG. 16 shows further details of an extractor hood according to the invention, partly in section;

FIG. 17 shows the extractor hood of FIG. 16 in its folded position;

FIG. 18 shows another embodiment of an extractor hood according to the invention;

FIG. 19 shows the extractor hood of FIG. 18 in its horizontal working position, cf. FIG. 4;

FIG. 20 shows another embodiment of an extractor hood according to the invention;

FIG. 21 shows an alternative design of the embodiment in FIGS. 16 and 17;

FIG. 22 shows a different view of the embodiment in FIG. 21;

FIG. 23 shows the combined use of the cooking device of the extractor hood and an additional cooking hob.

FIG. 24 shows another view of the embodiment in FIG. 23;

FIG. 25 shows another embodiment of the extractor hood;

FIG. 26 shows another view of the embodiment in FIG. 25;

FIG. 27 shows another embodiment of the extractor hood;

FIG. 28 shows another view of the embodiment in FIG. 27;

FIG. 29 shows another embodiment of the extractor hood;

FIG. 30 shows another view of the embodiment in FIG. 29;

FIG. 31 shows another view of the embodiment in FIG. 29;

FIG. 32 shows the embodiment of FIG. 29 with folded-in cooking device;

FIGS. 33-36 show further details of the embodiment in FIG. 27;

FIGS. 37-39 show further details with respect to grease evacuation in the embodiment of FIG. 27; and

FIGS. 40 and 41 show a variant of the extractor hood in FIG. 20.

### DETAILED DESCRIPTION

In all the figures, the reference numerals are the same or at least have the same effect.

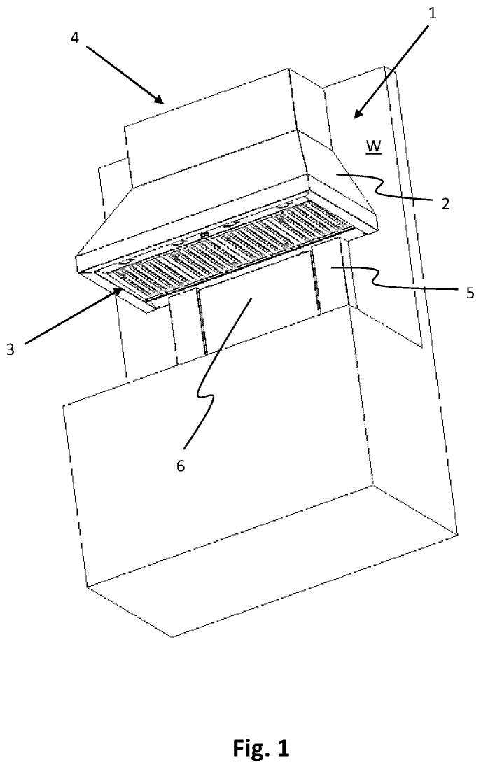

FIG. 1 shows a first embodiment of the extractor hood according to the invention in a perspective view. The extractor hood is designated overall by the reference numeral 1. In the present case, it is designed as a so-called chimney hood. The extractor hood 1 comprises a body or a housing 2, which body 2 has an inlet portion 3 and an outlet portion 4. Through the inlet section 3, cooking fumes and vapours are drawn in from a cooking hob (not shown here) arranged below the extractor hood 1 and then discharged to the outside through the outlet section 4 via an exhaust chimney (not shown) or—after corresponding filtering—fed back into the ambient air.

A fan is arranged in the body or housing 2 for this purpose, which is familiar to those skilled in the art, but which fan cannot be seen in the illustration in FIG. 1.

The body or housing 2 has a box-shaped portion 5 below the inlet section 3, which a box-shaped portion 5 can be integral with the rest of the body 2 and is preferably to be arranged along a (kitchen) wall W when the extractor hood 1 is installed. In this box-shaped portion 5, a foldable and unfoldable cooking device 6 is arranged, which cooking device 6 can in particular assume the folded-in or second position shown in FIG. 1, while the unfolded position is also referred to as the first position in the following. This will be described in more detail below with reference to the further figures.

The further design of the actual extractor hood 1, i.e., the area between the inlet portion 3 and the outlet portion 4, does not need to be described in more detail below because this is not the subject of the present invention and because the skilled person is sufficiently familiar with it.

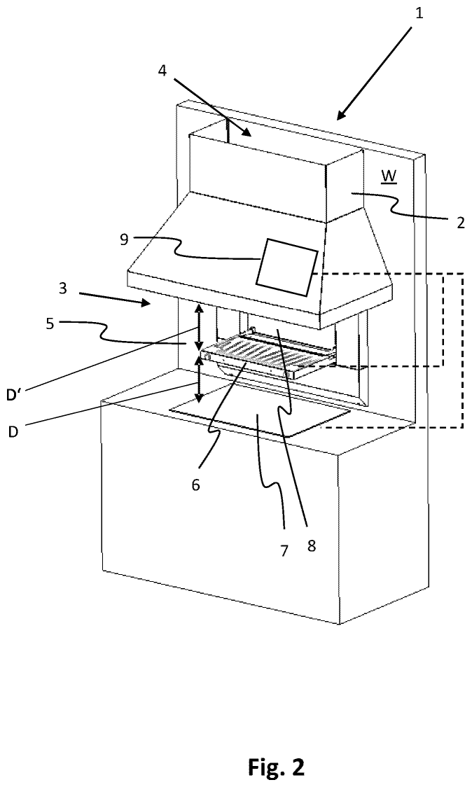

FIG. 2 shows the extractor hood 1 of FIG. 1 in a slightly different perspective view and with the cooking device 6 in the unfolded first position. In this first position, the cooking device 6 can be used to prepare food. In particular, the cooking device 6 is a barbecue grill, as shown, or a hotstone or a plancha. As can be seen from FIG. 2, in the unfolded position the cooking device is at a clear height, i.e., distance D, from an additional cooking hob 7, which cooking hob is conventionally installed in a (kitchen) worktop. Preferably, said distance D is between 10 and 30 cm, while a distance D′ between inlet portion 3 and cooking device 6 is about 25 to 35 cm, preferably about 30 cm.

The additional cooking hob 7 and the extractor hood 1 according to the invention together form a cooking system according to the invention, as defined in the appended claims.

As can further be seen from FIGS. 1 and 2, the box-shaped portion 5 surrounds the cooking device 6 at least in the folded second position or forms a recessed receptacle 8 for the cooking device 6, as can be seen well in particular in FIG. 2.

Preferably, the extractor hood 1 comprises a control unit 9, shown only schematically in FIG. 2, which is designed and set up so that, on the one hand, the cooking hob 7 and the cooking device 6 can only be operated separately from one another and, on the other hand, ensures that the cooking device 6 in particular can only be operated if said fan of the extractor hood 1 is active at the same time.

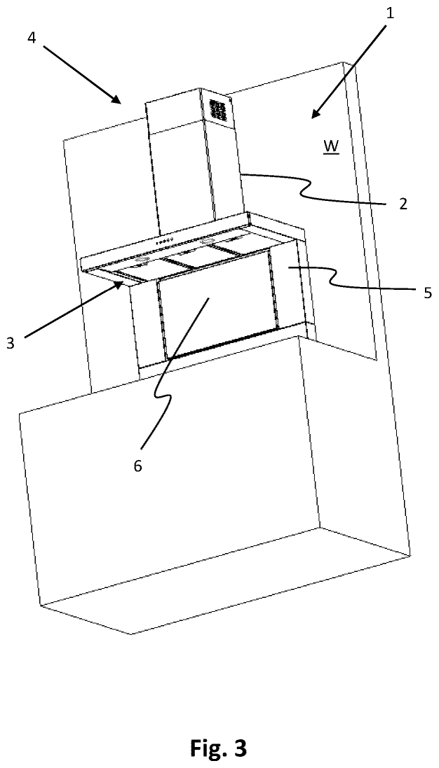

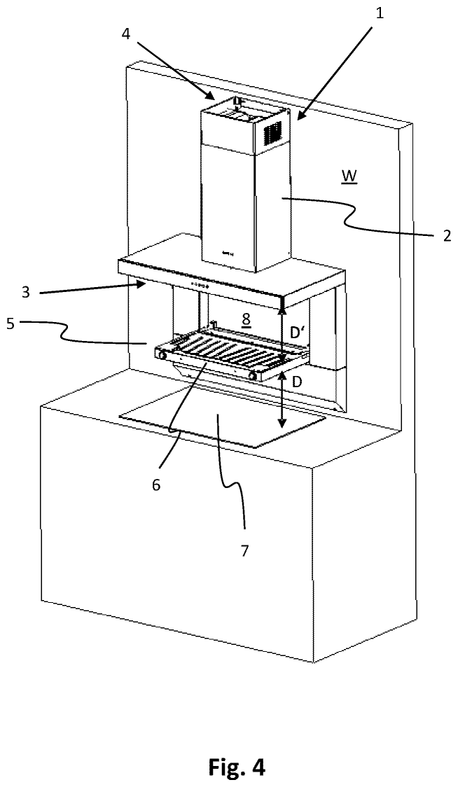

FIGS. 3 and 4 show a slightly modified form of the extractor hood 1 according to the invention, also referred to as a T-shaped hood. However, with regard to the box-shaped portion 5 and the cooking device 6, the design relates to the previously described design according to FIGS. 1 and 2. This also applies to the control unit 9 shown in FIG. 2.

In both cases the cooking device 6 is in the unfolded first state at a clear free distance above the cooking hob 7, which free distance D is preferably between 10 and 30 cm, most preferably about 20 cm, while a free distance D′ between inlet portion 3 and cooking device 6 is about 25 to 35 cm, preferably 30 cm, as already stated above.

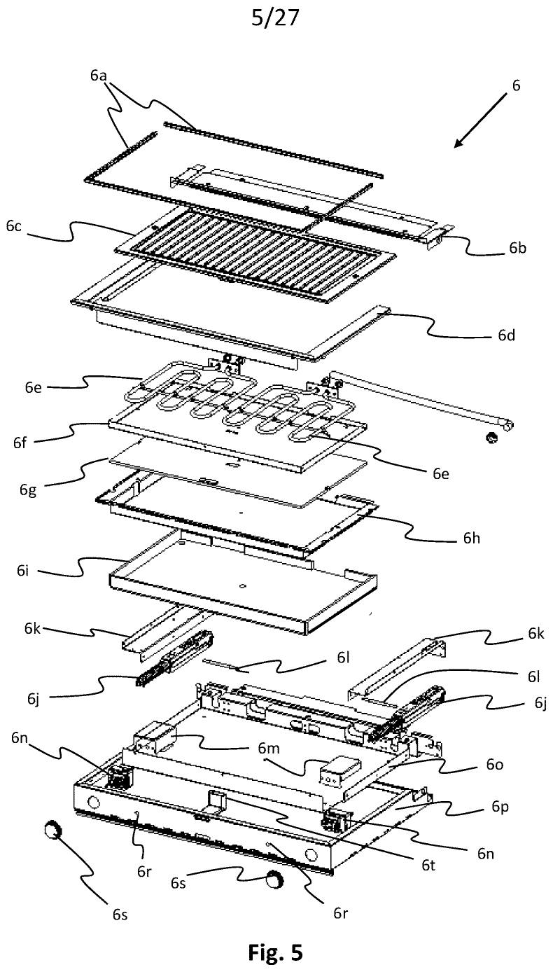

FIG. 5 shows an exploded view of the exact construction of the cooking device 6. This comprises (from top to bottom in FIG. 5) silicone gaskets 6a, a rear cover part 6b, the actual cooking plate 6c (preferably in the form of a cast iron grill), an outer frame 6d, two electric heating elements 6e (which can be activated either individually or together), a metallic insulating plate 6f (for heat reflection), an insulating plate 6g made of ceramic fibres, a further metallic insulating plate 6h (for heat reflection) and a further insulation 6i made of ceramic fibres, which is essentially of drawer-type and at least partially accommodates the components shown above in their assembled state.

Also shown below the insulation 6i are two hinges 6j for folding and unfolding the cooking device 6 with corresponding covers 6k made of metal, two capillary thermostats 6l with corresponding protective covers 6m, two temperature control units 6n (for cooperation with a respective one of the thermostats 6l), a component support bracket 6o and a drawer-shaped casing or receptacle 6p with front light indicators 6r for an activation state of the two heating elements 6e, respectively, and corresponding knobs 6s for setting a (cooking) temperature of the heating elements 6e. Reference numeral 6t indicates a grease drain element, which will be discussed in more detail below. The knobs 6s cooperate with the thermostats 6l and the temperature control units 6o, in a manner known per se, to set or maintain a desired temperature for the heating elements 6e.

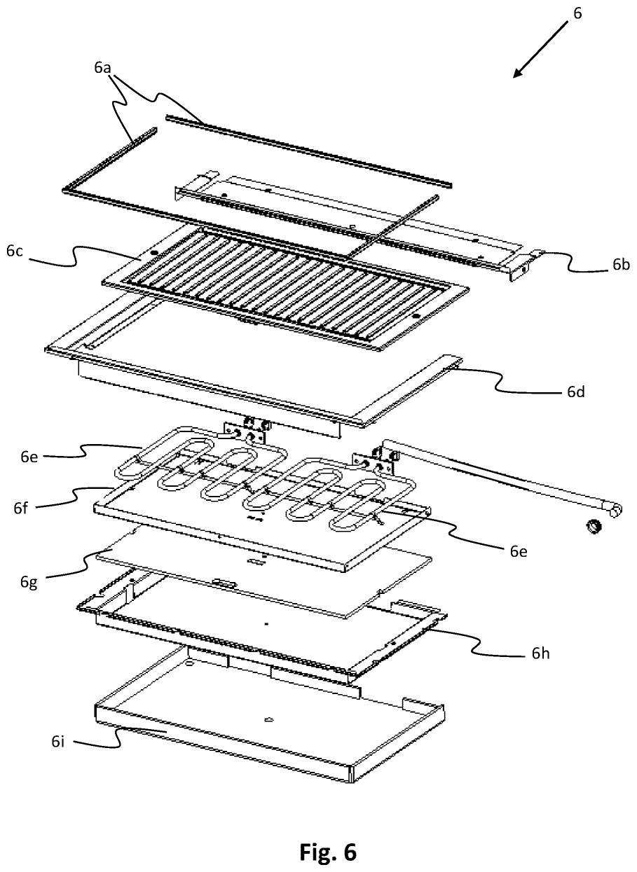

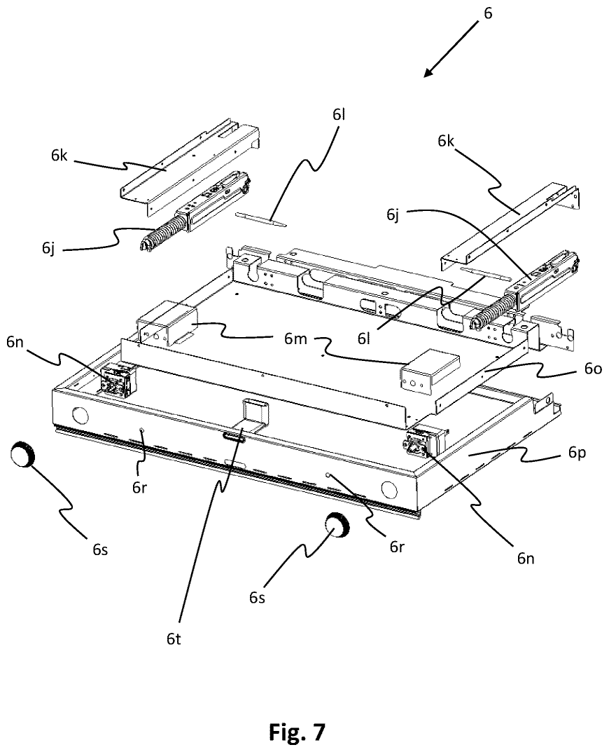

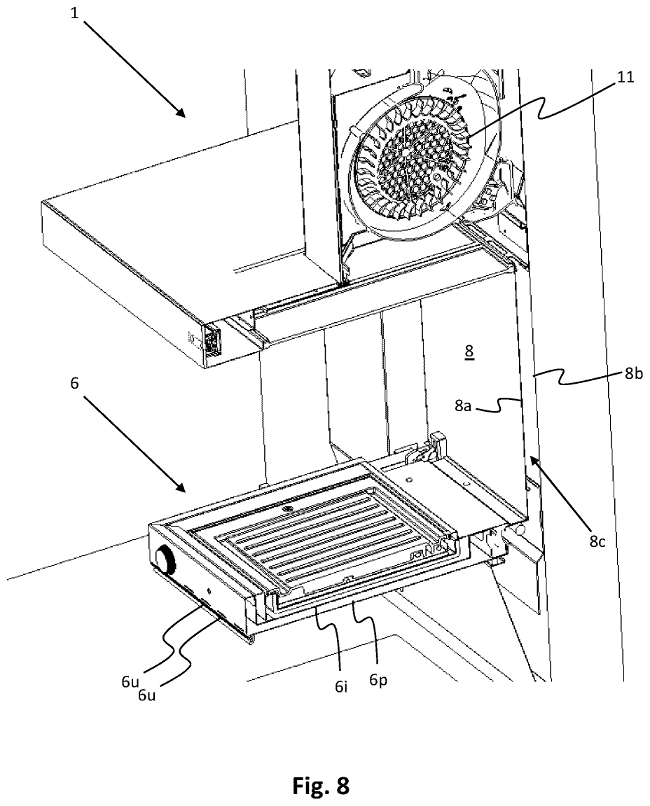

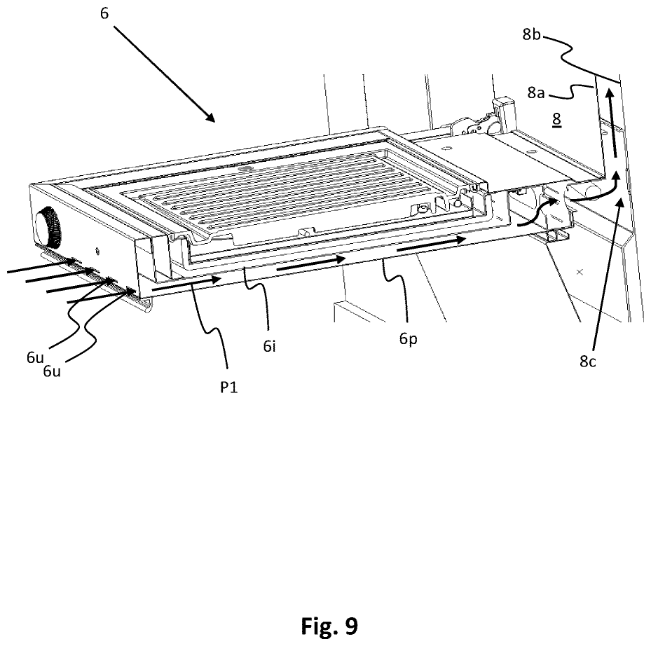

In FIGS. 6 and 7, the elements 6a to 6t of the cooking device 6 already described with reference to FIG. 5 are shown again enlarged and separately. These elements 6a to 6t are joined together to form the cooking device 6, as can be seen in particular in FIGS. 8 and 9.

In addition, FIGS. 8 and 9 show a first possibility of providing ventilation and corresponding cooling for the cooking device 6.

Not all of the above-mentioned elements are explicitly denoted again in FIGS. 8 and 9.

As the sectional view in FIG. 8 shows, the interior of the cooking device 6 is fluidly connected to the fan of the extractor hood 1 shown at reference numeral 10. For this purpose, the extractor hood 1 has a double rear wall 8a, 8b in the box-shaped region 5 or the receptacle 8 for the cooking device 6, so that an intermediate space 8c is formed via which the cooking device 6 is connected in a fluid-conducting manner to the fan 10. For this purpose, the cooking device 6 has apertures 6u at the front and at the sides in the area of the receptacle or casing 6p so that outside air can flow between the receptacle or casing 6p and the insulation 6i into the intermediate space 8c via suitable openings (not designated) in the rear components of the cooking device 6 when the fan 10 is active. This outside air can then be discharged together with other exhaust air by means of the fan 10.

FIG. 9 shows an example of the corresponding flow path (arrows P1).

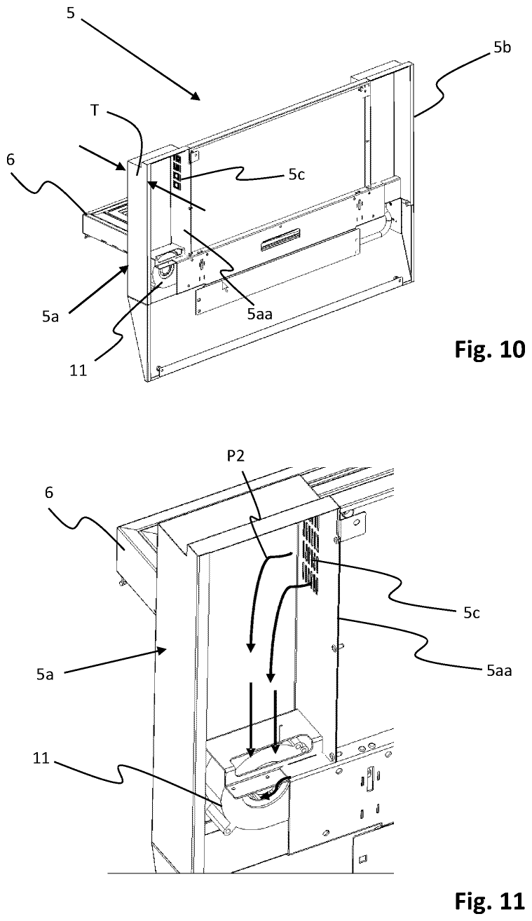

FIGS. 10 to 13 show an alternative design of the extractor hood 1 (of which only the lower box-shaped portion 5 and the cooking device 6 are shown here) for the purpose of cooling the cooking device 6.

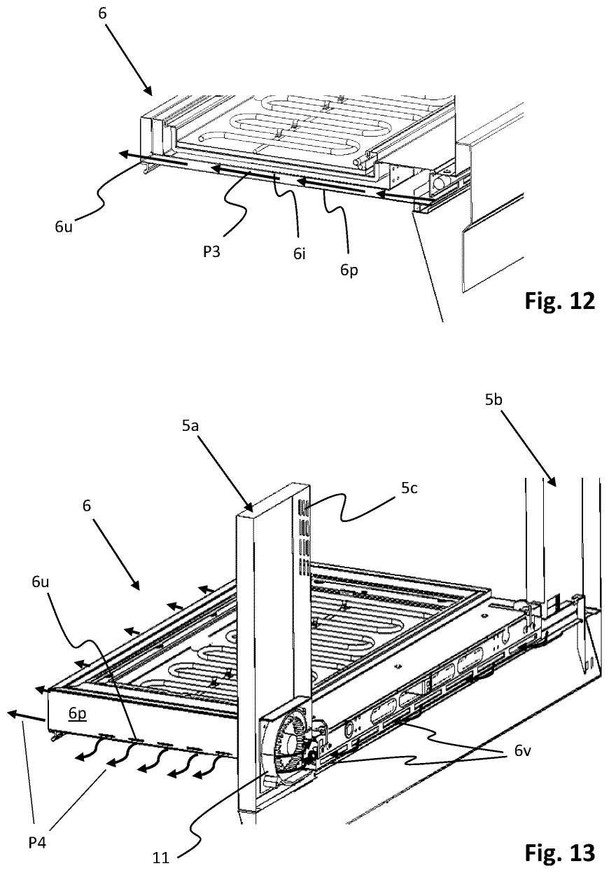

As can be seen from FIGS. 10 and 11, the lower box-shaped portion 5 has two lateral areas 5a, 5b of greater overall depth T than the recessed middle portion to the side of the receptacle 8, of which one portion 5a accommodates an additional fan 11, which additional fan 11 is arranged in a lower area approximately at the height of the unfolded cooking device 6. Furthermore, an inner boundary wall 5aa of the portion 5a has apertures or air intake openings 5c, via which apertures 5c the additional fan 11 is connected in a fluid-conducting manner to an outer area of the extractor hood 1. In this way, the additional fan 11 can draw in outside air through the portion 5a via the openings 5c, as shown in FIG. 11 (arrows P2). As can be seen in particular from FIGS. 12 and 13, the fan 11 is in fluid communication with the aforementioned area between the receptacle 6p and the insulation 6i via suitable openings 6v in the rear area of the cooking device 6. In this way, the outside air drawn in by the additional fan 11 can flow through the cooking device 6 as shown by the arrows P3 in FIG. 12 and then flow out again via the aforementioned openings or apertures 6u (arrows P4, FIG. 13). In this way, the cooking device 6 can be cooled effectively.

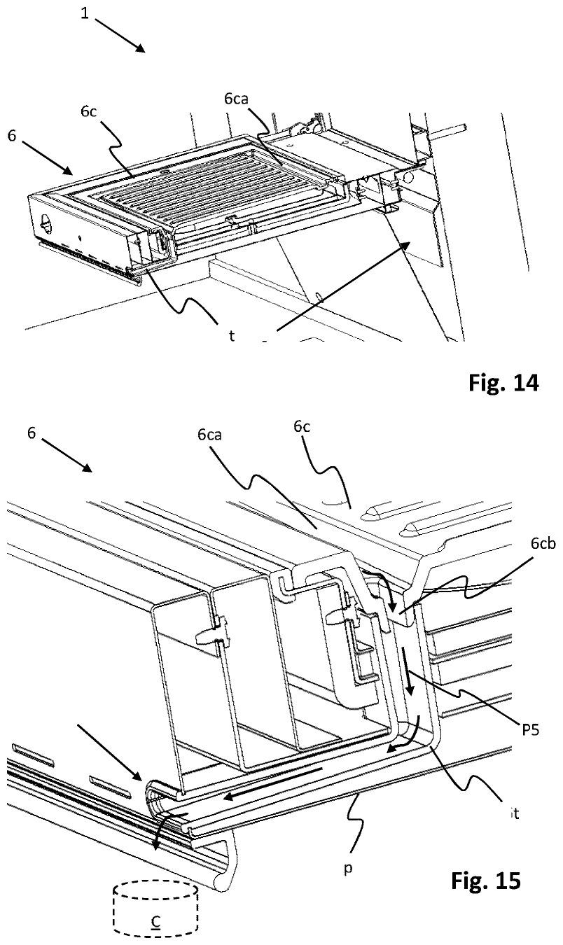

FIGS. 14 and 15 show another preferred detail of the extractor hood 1 according to the invention. As can be seen from the drawings, there is a circumferential channel 6ca for discharging cooking fat or grease, which channel 6ca surrounds the cooking plate 6c. Preferably, the channel 6ca is formed integrally with the cooking plate 6c in such a way that it is deeper in a front area of the cooking device 6, i.e., in an area facing away from the box-shaped portion 5, than in the rear area, so that cooking or frying fat naturally flows off toward said front area of the cooking device 6 in the channel 6ca (for which purpose the channel 6ca can be slanted forward in the lateral areas, which cannot be seen in the drawings). At the front, the channel 6ca has a downward opening 6cb (cf. FIG. 15), which opening 6cb cooperates with the aforementioned grease drainage element 6t referred to above. The grease drainage element 6t opens at the front of the cooking device 6 (at reference numeral 6ta) thus creating a fluid connection with an outside of the extractor hood, i.e., the cooking device 6, so that grease can flow out of the cooking device 6 according to the arrows P5. To collect the grease, a suitable container C can be placed in this area (shown schematically).

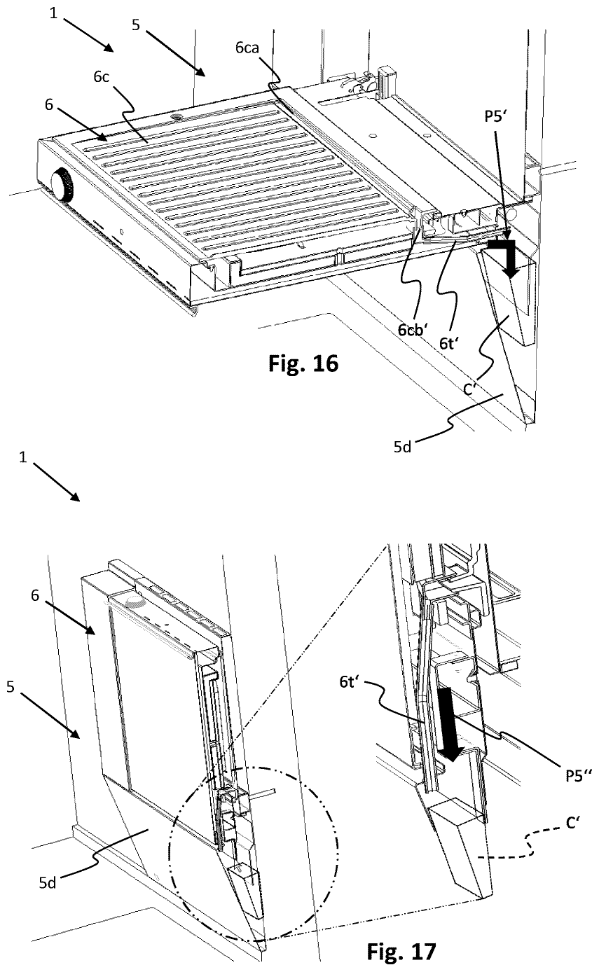

FIGS. 16 and 17 show another advantageous embodiment of the extractor hood 1 according to the invention. As can be seen from the drawings, there is again a circumferential channel 6ca for discharging cooking fat or grease, which channel 6ca surrounds the cooking plate 6c, as in FIGS. 14 and 15. Preferably, in contrast to the embodiment of FIGS. 14 and 15, the channel 6ca is formed integrally with the cooking plate 6c in such a way that it is deeper in a rear area of the cooking device 6, i.e., in an area facing toward the box-shaped portion 5, than in the front area, so that cooking or frying fat naturally flows off toward said rear area of the cooking device 6 in the channel 6ca (for which purpose the channel 6ca can be slanted rearward in the lateral areas, which cannot be seen in the drawings). At the rear, the channel 6ca has a downward opening 6cb′, which opening 6cb′ cooperates with a grease drainage element 6t′ in analogy to element 6t referred to above. The grease drainage element 6t′ opens at the rear of the cooking device 6 thus creating a fluid connection so that grease can flow out of the cooking device 6 according to arrow P5′. To collect the grease, a suitable and preferably removeable container C′ can be located (attached) inside a lower fixed part of body 2, i.e., of box-shaped portion 5 (shown schematically) behind a cover element 5d.

As shown in FIG. 17, this particular system for the evacuation of the grease generated during the cooking can also prevent any grease from pouring into the rear area of the cooking device 6 when the latter is in its closed position.

As already explained before, in a back wall of the cooking device 6 fat collection is obtained by means of an opening that it connected to a pipe (said grease drainage element 6t′) that puts it in fluid communication with said removable grease container C′ located in the lower fixed cover of the box-shaped portion 5.

The grease evacuation path allows any grease to be discharged along arrow P5′ and P5″, respectively, both when the cooking device 6 is in its working position (horizontal, cf. FIG. 16) and when it is in its closed position (vertical, cf. FIG. 17).

FIG. 18 shows another embodiment of the extractor hood 1 according to the invention, similar to FIG. 3. In this embodiment, the extractor hood 1 comprises two infrared temperature sensors 3a in an area of the inlet portion 3, as shown. There can be only one sensor 3a, and the sensor(s) 3a could be located in various places. The dashed triangular areas symbolize a detection region of a given sensor 3a.

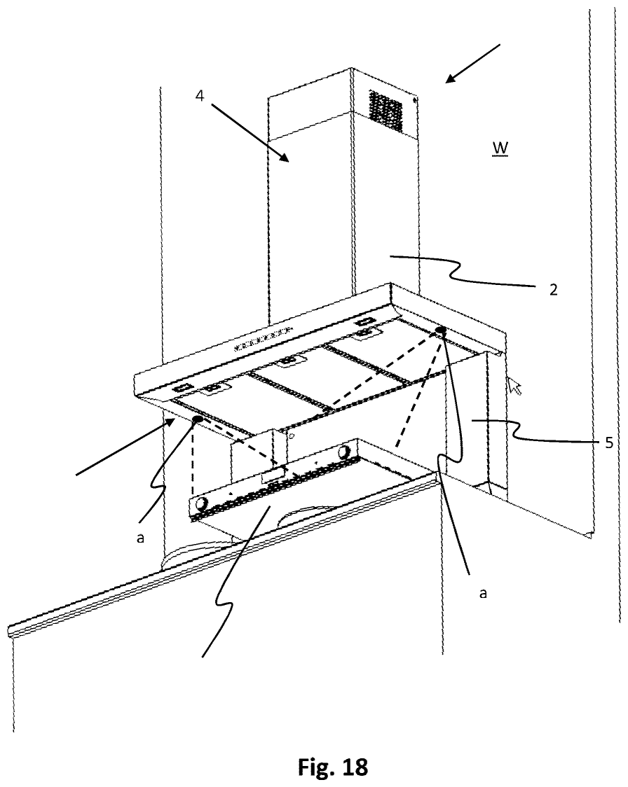

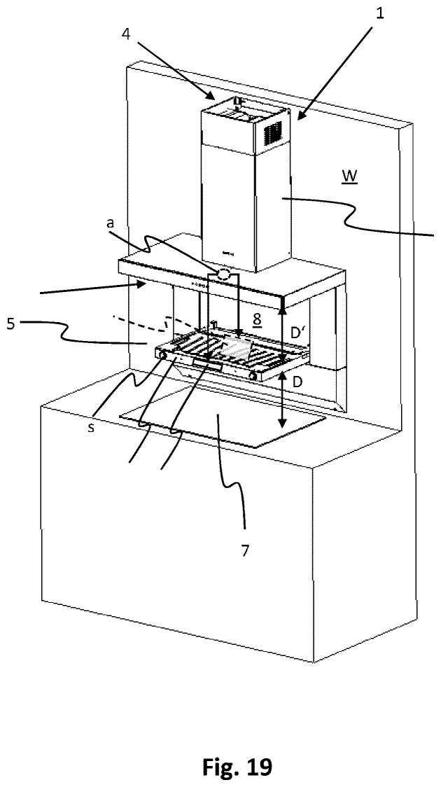

FIG. 19 shows the extractor hood 1 of FIG. 18 with cooking device 6 in its horizontal working position, cf. FIG. 4. Cooking device 6, in the embodiment shown, comprises a temperature control unit 12 (which is equivalent to the two temperature control units 6n for cooperation with a respective one of the thermostats 6l, as explained above with reference to FIG. 5) and a display 13, both of which cooperate with temperature sensor 3a. This allows controlling an actual cooking temperature of cooking device 6, which can be pre-set and/or altered via knobs 6s, by means of sensor 3a and control unit 12 and displaying said temperature via display 13.

In accordance with another highly preferred embodiment, the extractor hood 1 further comprises a temperature sensor 3a (e.g., as defined above) and/or a humidity sensor (which can advantageously be integrated with the temperature sensor 3a and is therefore not depicted separately), which automatically turns (or turn) on the hood at a (pre-)defined fan speed at the moment when, during cooking, the sensor/s detect/s a temperature between 30° C. and 40° C. and/or a humidity level around 70% in order to optimize the capture of fumes or vapors that are generated at the first moments of cooking. To this end, the temperature and/or humidity sensor/s 3a are operatively connected to the hood's control unit 9, as shown in exemplary fashion in FIG. 2.

It should be noted that the additional features explained in connection with FIGS. 18 and 19 can be used with any other embodiment of the present invention.

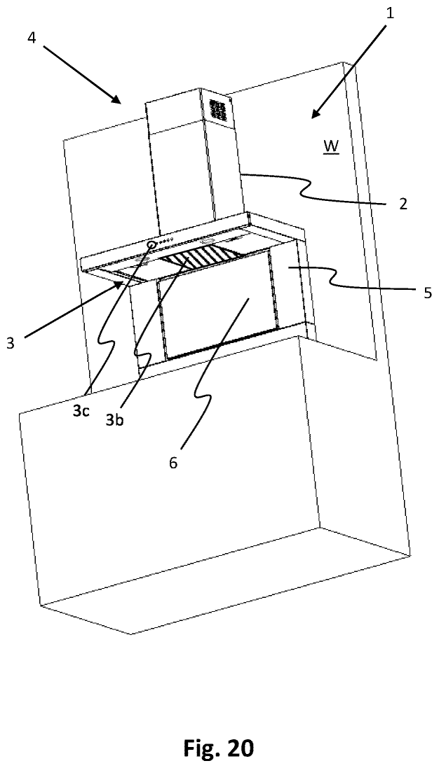

The same holds with respect to the embodiment of FIG. 20.

FIG. 20 shows the extractor hood 1 as previously explained with reference to FIG. 3. In addition to said extractor hood 1, the embodiment of FIG. 20 further comprises at least one additional heating element in the form of an infrared heating element under glass ceramic, as denoted by reference numeral 3b. Said additional heating element 3b is located in an area of said inlet portion 3 and allows simultaneous cooking from above as well as from below, if the cooking device 6 is folded out and activated. Furthermore, additional heating element 3b could be used separately from cooking device 6 for to keep prepared food at an elevated temperature prior to serving. Additional heating element 3b can be operated by knobs 6s (cf. FIG. 7) or by means of a dedicated control element 3c, as shown in exemplary fashion.

Furthermore, the additional heating element 3b can advantageously be lowered in the direction of the cooking device 6, either manually or by including suitable motor and operating means (not shown).

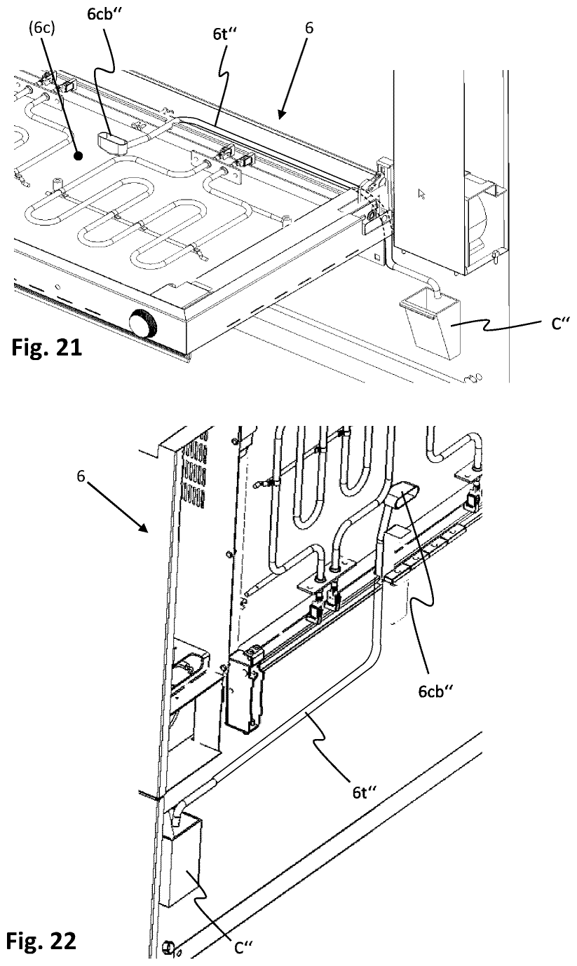

FIGS. 21 and 22 shown an alternative embodiment of the system for the evacuation of grease generated during the cooking (cf. FIGS. 16 and 17) to prevent it from pouring into the rear area of the hood when the cooking device 6 is closed.

In the cooking plate 6c (omitted for clarity, cf. FIG. 16), fat collection is obtained by means of a central opening 6cb″ connected to a pipe 6t″ that puts it in communication with a removable grease container C″ placed in the lower fixed cover (box-shaped portion 5) of the hood, which container C″ is normally not visible as it is hidden behind a cover element (not shown, cf. FIG. 16). The cooking plate 6c is preferably slanted towards said central opening 6cb″.

The grease evacuation path is laid out in such a way that allows the grease to be discharged both when the cooking device 6 is in the working position (horizontal, FIG. 21) and when it is in the closed position (vertical, FIG. 22).

FIGS. 23 and 24 show the possible use of the cooking device 6 together with an additional cooking hob 7, as described before. As stated, it may be possible to use, e.g., two pans 14a, 14b with a limited height H of about 5 cm maximum on the two front hob heaters 7a, 7b.

It should be noted that the described design of the foldable cooking device 6 together with the cooling features and/or the grease evacuation can be realized regardless of its distance from the cooking hob 7 and/or from the inlet portion 3.

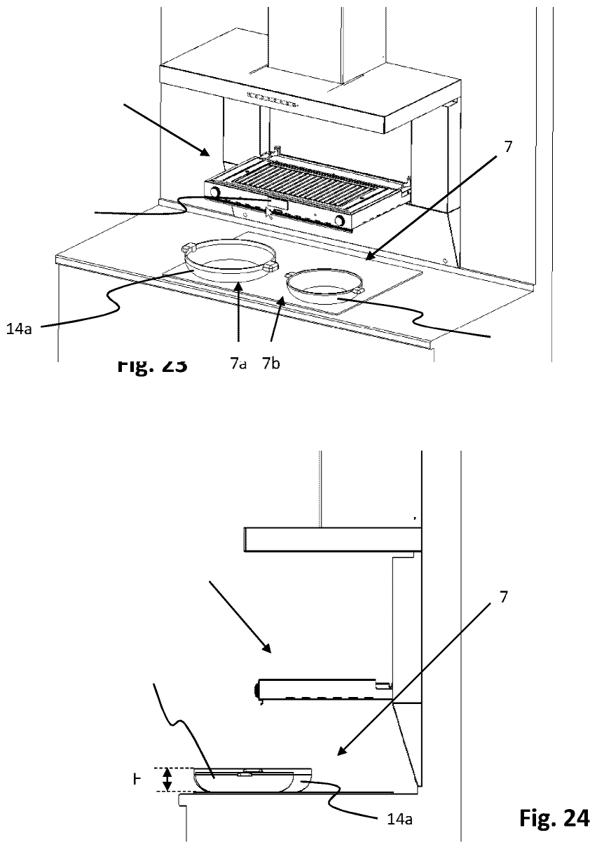

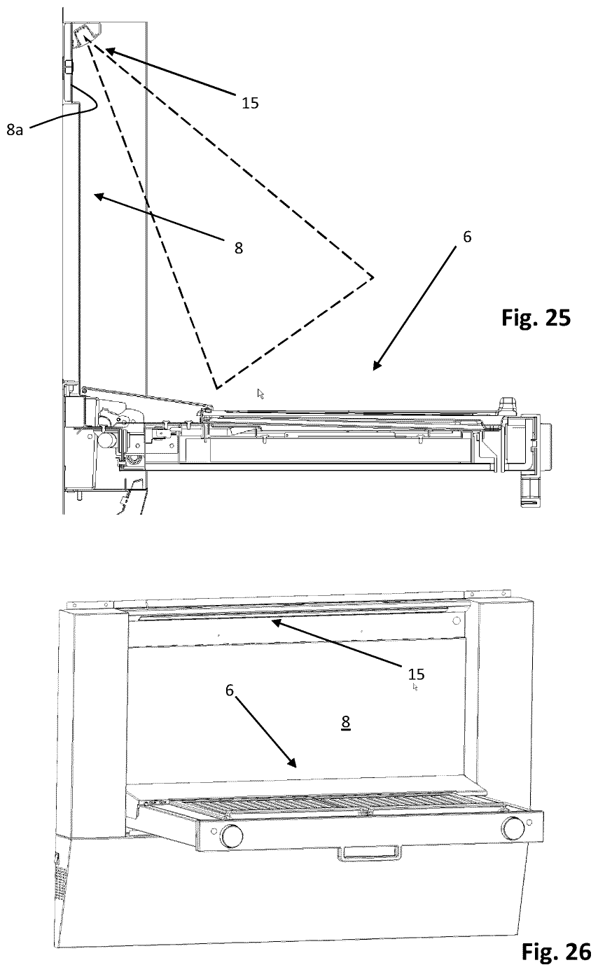

FIGS. 25 and 26 show details of another embodiment of the extractor hood, wherein a lighting system in the form of an LED light bar 15 is arranged in the top portion of the rear panel or rear wall 8a of the barbecue (i.e., of the aforementioned receptacle 8) to optimize the lighting of the cooking area of the folded-out cooking device 6, as symbolized by the dashed triangle in FIG. 25. The lighting system 15 can be fixed or orientable. It can light up automatically when folding out the cooking device 6, or there can be provided an additional switching element (not shown) for operating the lighting system 15. It can also be operated by means of a luminosity sensor (not shown).

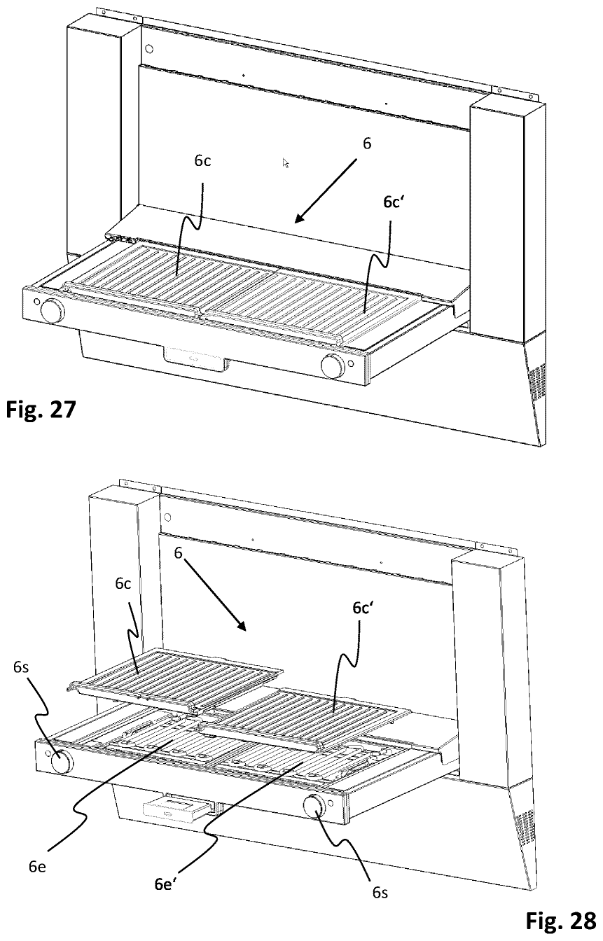

FIGS. 27 and 28 show another highly preferred embodiment of the extractor hood that further comprises, in connection with the foldable cooking device 6, a cooking zone that comprises two cast iron plates 6c, 6c′ that are placed side by side in order to enable the possibility of cooking food at different temperatures in the corresponding (e.g., right and left) areas of the cooking zone. To this end, the cooking device 6 also includes two heating elements 6e, 6e′ with different adjustable temperatures, e.g., via knobs 6s (cf. FIG. 5).

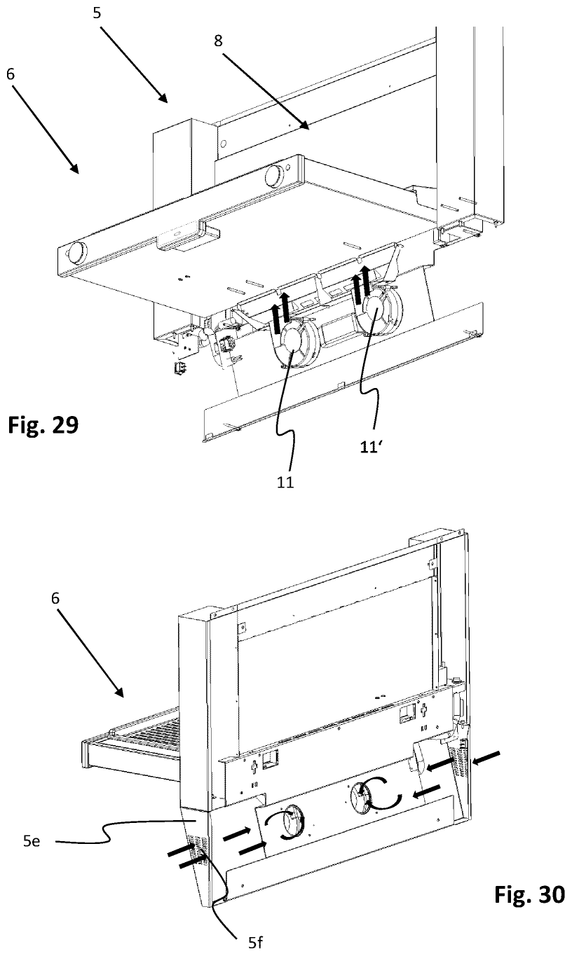

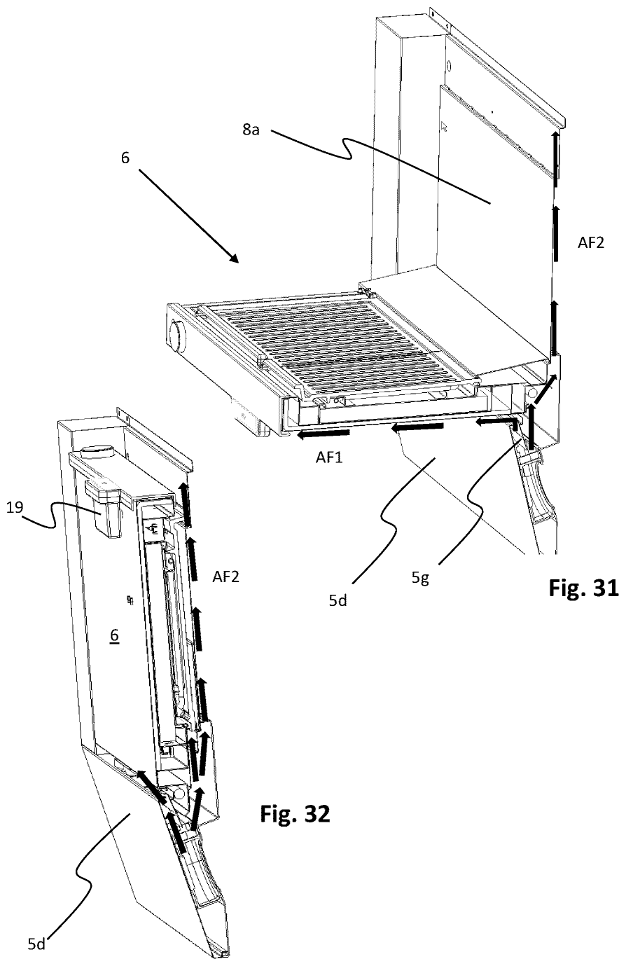

FIGS. 29-32 show another highly preferred embodiment, wherein the extractor hood comprises a different division of the the cooling air path (compare, e.g., FIGS. 12 and 13) in order to reduce the temperature of the area of the rear vertical panel of the barbecue (i.e., the foldable cooking device) in case the user closes the barbecue just after having finished cooking with the cooking plates still very hot. As can be seen in FIG. 29, the extractor hood comprises two additional fans 11, 11′, which fans are located behind an inclined cover element 5d as previously shown in FIG. 16. Said fans 11, 11′ are arranged to take in air from outside the extractor hood and to push said air along an air flow path on an outside (underside) of said casing 6p, i.e., of said cooking device 6, in particular in a folded-out state thereof (cf. FIG. 9 and FIG. 31).

Said cover element 5d is inclined with respect to said wall of the kitchen (cf. FIGS. 1 and 2). The additional fans 11, 11′ are located behind said cover element 5d, in a space delimited by said cover element 5d and by additional side cover elements 5e that are visible in FIG. 30. Said space has several air intake openings 5f in said side cover elements 5e for supplying air to said additional fans 11, 11′ and opens toward said air flow path along the outside (underside) of said casing 6p (cf. the horizontal arrows AF1 in FIG. 31).

Additionally, the air flow provided by said additional fans 11, 11′ is divided, by means of a corresponding air flow divider 5g (cf. FIG. 31) located at (close to) said fans 11, 11′, into an air flow (first air flow) that is oriented toward said air flow path AF1 along the outside (underside) of said casing 6p—or through the casing, as stated before—and into another air flow (second air flow AF2, cf. FIG. 31, vertical arrows) that is guided behind a rear wall 8a (or alternatively between a double rear wall 8a, 8b, cf. FIG. 9) of the box-shaped region or the receptacle for the cooking device 6, e.g., in an intermediate space that is formed between the two rear walls 8a, 8b (FIG. 9) or behind a single rear wall 8a (FIG. 31).

At least the second air flow AF2 can be present even if the cooking device 6 is folded in, cf. FIG. 32, so that a cooling effect still results if the user closes the cooking device 6 shortly after having finished cooking with the cooking plates still very hot.

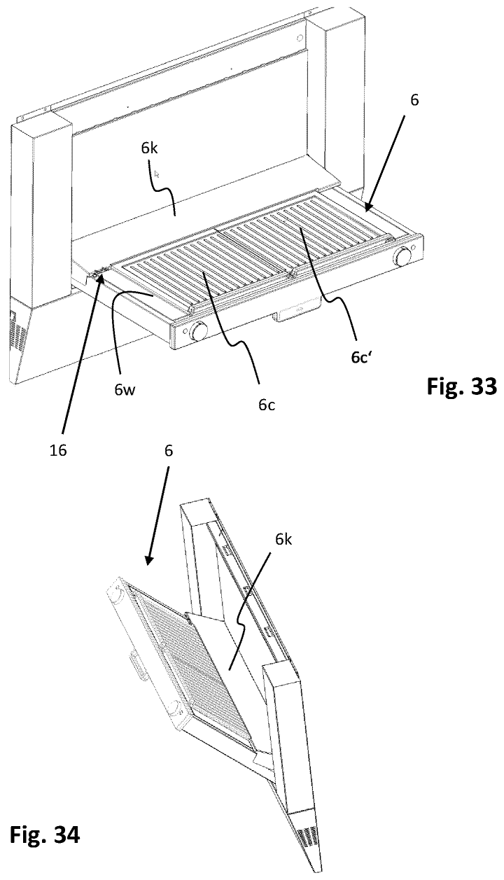

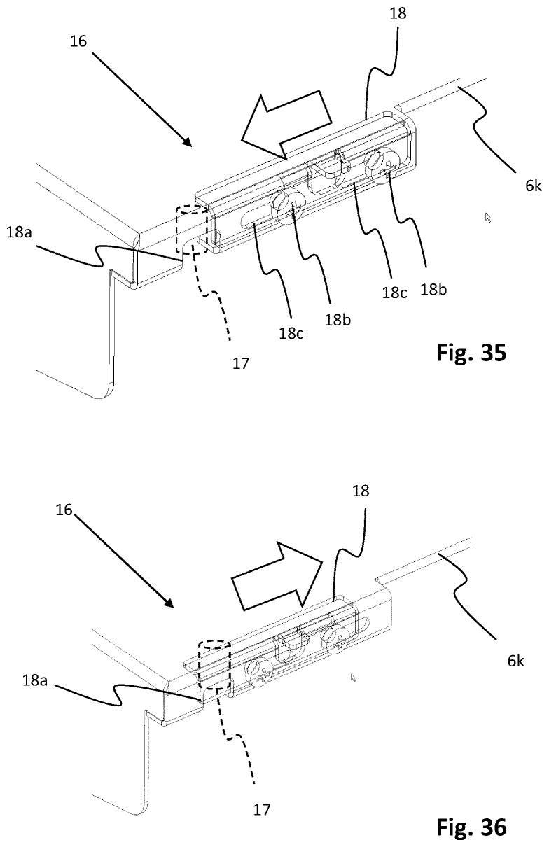

FIGS. 33-36 are intended to show an embodiment of the locking system. Said locking system 16 comprises at least one protruding structure (e.g., a pin) 17 on an upper side 6w (cf. FIG. 33) of the cooking device 6 (in a folded-out state thereof). A single hinge cover part 6k is provided, which hinge cover part 6k covers the hinges 6j (cf. FIG. 5) and is devised to be in continuous contact with said upper side 6w of the cooking device 6, e.g. for to cover a area between a rear portion of the cooking device 6 and said box-shaped portion or the receptacle 8 for the cooking device 6 (e.g., to prevent items from falling into said area and blocking the folding mechanism). The locking system 16 also comprises a movable locking structure 18 that interacts with said protruding structure 17. To this end, the locking structure 18 comprises an opening (e.g., a cut-out) 18a and is moveable (manually) between a first position, as shown in FIG. 35, in which the protruding structure 17 can pass through said opening 18a when folding the cooking device 6 in or out, and a second position, shown in FIG. 36, in which the protruding structure 17 cannot pass through said opening 18a. Thus, by moving or sliding the locking structure 18 once the cooking device 6 is folded out, one can block the cooking device 6 in its folded-out position, and it cannot fold in when the weight of the cooking plates 6c, 6c′ (cf. FIG. 27, 28) is removed.

As shown in FIGS. 35 and 36, said locking structure 18 can be devised as a simple sliding latch that is slidably held by means of two screws 18b which are guided in corresponding elongated holes 18c. Sliding motion of locking structure 18 is possible in the direction of the arrows shown in FIGS. 35 and 36.

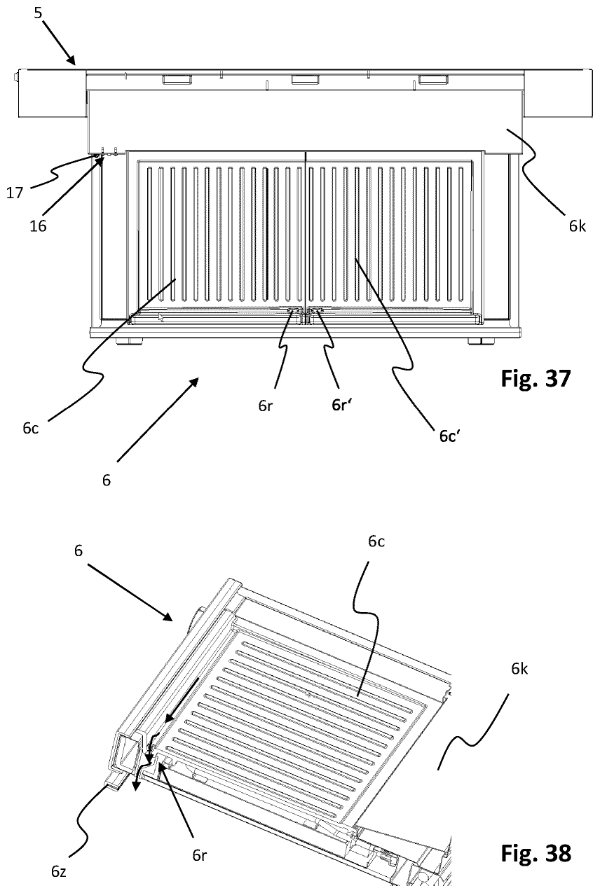

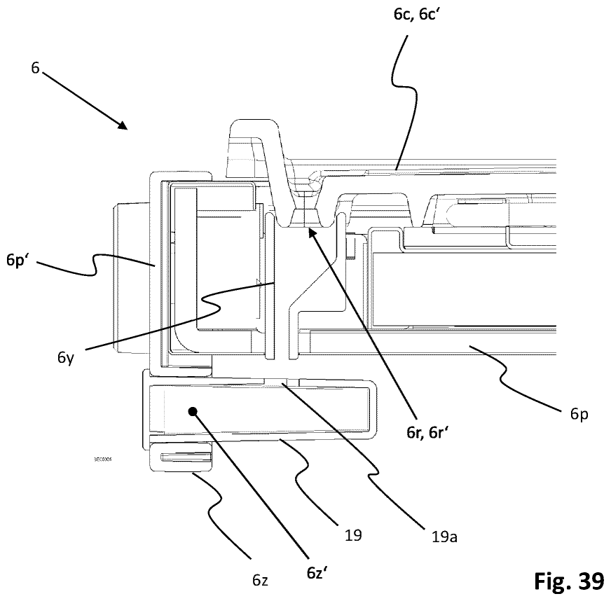

FIGS. 37-39 show an alternative grease evacuation feature, cf. FIGS. 15-17, 21-22, for cooking devices with a plurality of cooking plates 6c, 6c′. Each cooking plate 6c, 6c′ has a hole 6x, 6x′ in a central front portion thereof (with respect to the cooking device 6 as a whole). Below said hole 6x, 6x′ and in fluid connection therewith is a channel piece 6y that extends all the way through the cooking device 6 (including casing 6p) and opens at an underside thereof. Casing 6p, i.e., a front panel 6p′ thereof, has a lower extension 6z with throughhole 6z′, in which is inserted a tapering removable grease tray 19 that has an upper opening 19a which is located right underneath said channel piece 6y, when the grease tray is correctly inserted, as shown in FIG. 39.

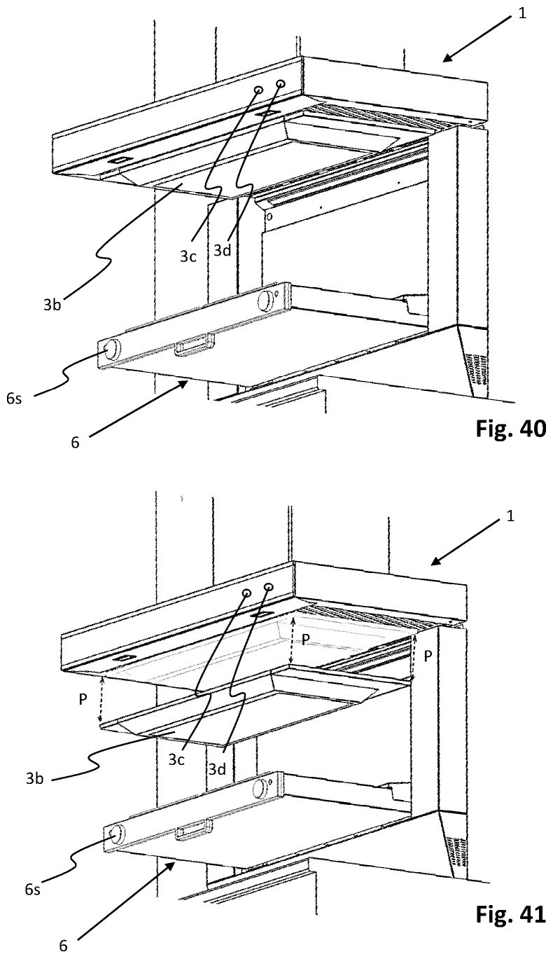

FIGS. 40 and 41 show the extractor hood 1 as previously explained with reference to FIGS. 3 and/or 20. In addition to said extractor hood 1, the embodiment of FIGS. 40 and 41 further comprises at least one additional heating element in the form of an infrared heating element under glass ceramic, as denoted by reference numeral 3b. Said additional heating element 3b is located in an area of said inlet portion 3 and allows simultaneous cooking from above as well as from below, if the cooking device 6 is folded out and activated. Furthermore, additional heating element 3b could be used separately from cooking device 6 for to keep prepared food at an elevated temperature prior to serving. Additional heating element 3b can be operated by knobs 6s (cf. FIG. 7) or by means of a dedicated control element 3c, as shown in exemplary fashion. Furthermore, as illustrated in FIG. 41, said additional heating element can advantageously be devised so that it can be lowered in the direction of the cooking device 6, either manually or by including suitable motor and operating means 3d (cf. arrows P). In this way, cooking time can be further reduced. After cooking, the additional heating element 3b can be moved up again and stowed in (or at) the extractor hood 1.

Of course, the skilled person will freely combine any of the features shown in the drawings if such combination yields a further useful embodiment of the present invention.

1. A kitchen extractor hood (1), comprising:
a body (2) adapted for positioning at a wall (W) of the kitchen, said body (2) having an inlet portion (3) and an outlet portion (4);
a fan (10) arranged in said body (2) for sucking in cooking fumes and vapours, from a cooking hob (7) above which the extractor hood (1) is adapted to be positioned, via said inlet portion (3) and for pushing said fumes and vapours through the outlet portion (4) out of the extractor hood (1);
the body (2) of the extractor hood (1) has a box-shaped portion (5) extending beyond the inlet portion (3), said box-shaped portion (5) supporting a retractable cooking device (6) having heating means (6e), the retractable cooking device is movable between a first position below said inlet portion (3) during use for preparation of food using said heating means (6e), in said first position the cooking device (6) being folded out of said box-shaped portion (5), and a second position, in said second position said cooking device (6) being folded back into said box-shaped portion (5) when not in use; and
said cooking device (6), when folded out, is located at a distance (D′) between 25 and 35 cm from the inlet portion (3).

2. The extractor hood (1) of claim 1, wherein
said cooking device (6) comprises at least one of a plancha, a hotstone, a barbecue grill, or a cast iron cooking plate (6c).

3. The extractor hood (1) of claim 1, wherein
said cooking device (6) comprises a casing (6p), in which at least said heating means (6e) are located, said casing (6p) comprising at least one of a thermal insulation or a thermally insulating material.

4. The extractor hood (1) of claim 3, wherein
said casing (6p) is in fluidic connection with said inlet portion (3), wherein said fluidic connection is provided by and passes through said box-shaped portion (5).

5. The extractor hood (1) of claim 3, wherein
said casing (6p) has at least one air intake opening (6v) in a portion below said heating means (6e).

6. The extractor hood (1) of claim 3, wherein
said body (2) comprises at least one additional fan (11), said at least one additional fan (11) is arranged to take in air from outside the extractor hood (1) and to push said air into said casing (6p).

7. The extractor hood (1) of claim 6, wherein
said casing (6p) has at least one air outlet opening (6u) in a portion below said heating means (6e).

8. The extractor hood (1) of claim 1, wherein
said box-shaped portion (5) has a recess (8) for engaging with the cooking device (6) in said second position and at least one lateral portion (5a, 5b) delimiting said recess (8), said lateral portion (5a).

9. The extractor hood (1) of claim 8, wherein
said body (2) comprises at least one additional fan (11), said at least one additional fan (11) is arranged to take in air from outside the extractor hood (1) and to push said air into said casing (6p), and said lateral portion (5a) has at least one air intake opening (5c) for supplying air to said additional fan (11) and is fluidically connected to an interior of said casing (6p).

10. The extractor hood (1) of claim 2, wherein a grease collecting channel (6ca) is arranged around the at least one of said hotstone, plancha or barbecue grill (6c), said grease collecting channel (6ca) being slanted, at least at lateral sides of the cooking device (6),
a) toward a front side of the cooking device (6), said front side facing away from said body (2) in said first position, said grease collecting channel (6ca) further having at least one fluid connection (6t) with an outside of the extractor hood (1) for evacuation of grease; or
b) toward a back side of the cooking device (6), said back side facing toward said body (2) in said first position, said grease collecting channel (6ca) further having at least one fluid connection (6t′) with a grease collecting recipient (C′) arranged within a lower part of said body for collection of grease, and said fluid connection (6t′) being operational in both said first and second positions of the cooking device (6).

11. The extractor hood of claim 10, wherein
said fluid connection (6t) is located at a front side of the cooking device (6) in said first position.

12. The extractor hood of claim 1, further comprising:
at least one temperature sensor (3a), said temperature sensor (3a) in operative connection with said cooking device (6), for controlling and/or displaying, respectively, a cooking temperature.

13. The extractor hood of claim 1, further comprising:
at least one additional heating element in an area of said inlet portion (3), to allow a simultaneous cooking from above as well as from below.

14. The extractor hood of, further comprising:
a lighting system (15) arranged at a top of a rear panel (8a) of the extractor hood.

15. The extractor hood of claim 1, further comprising:
a plurality of cooking plates (6c, 6c′), each said cooking plate (6c, 6c′) having a hole (6x, 6x′) in fluid connection with a channel piece (6y) that extends through the cooking device (6) and opens at an underside thereof, wherein the cooking device (6), has a lower extension (6z) holding a tapering removable grease tray (19) that has an upper opening (19a) which is located underneath said channel piece (6y), when the grease tray (19) is inserted in said extension (6z).

16. The extractor hood of claim 1, further comprising:
a locking system (16) that prevents the cooking device (6) from closing.

17. The extractor hood of claim 16, wherein
said locking system (16) comprises at least one protruding structure (17) on an upper side (6w) of the cooking device (6) and a movable locking structure (18) that interacts with said protruding structure (17), wherein the locking structure (18) comprises an opening (18a) and is moveable between a first position, in which the protruding structure (17) is adapted pass through said opening (18a) when folding the cooking device (6) in or out, and a second position, in which the protruding structure (17) cannot pass through said opening (18a).

18. The extractor hood of claim 3, further comprising:
in said body (2), at least one additional fan (11, 11′), said at least one additional fan (11, 11′) is arranged to take in air from outside the extractor hood and to push said air along an air flow path (AF1) on an outside of said casing (6p).

19. The extractor hood of claim 18, wherein
said box-shaped portion (5) comprises a lower fixed part of said body which includes a cover element (5d) located below the foldable cooking device (6), wherein the at least one additional fan (11, 11′) is located behind said cover element (5d), and a space delimited by said cover element (5d) and by additional side cover elements (5e) has at least one air intake opening (5f) for supplying air to said at least one additional fan (11, 11′) and opens toward said air flow path (AF1).

20. The extractor hood of claim 19, wherein
an air flow provided by said additional fan (11, 11′) is divided, by a corresponding air flow divider (5g), into a first air flow that is oriented toward said air flow path (AF1) and into a second air flow (AF2) that is guided along a rear wall (8a) in the box-shaped portion (5) or receptacle (8) for the cooking device (6).

21. The extractor hood of claim 1, further comprising:
a temperature sensor (3a) and/or a humidity sensor in operative connection with a control unit (9) that is configured to automatically turn on the extractor hood at a defined fan speed, during cooking, upon at least one of the temperature sensor or the humidity sensor detecting a temperature between 30° C. and 40° C. or a humidity level around 70%, respectively.

22. A cooking system, comprising:
a kitchen extractor hood (1) according to claim 1 and a cooking hob (7),
wherein the extractor hood (1) is placed above said cooking hob (7) and the cooking device (6), in the first position, is located at a free distance from said cooking hob (7), said free distance measuring between 10 and 30 cm.

23. The cooking system of claim 22, further comprising:
a control unit (9) configured to enable activation of the cooking device (6) in said first position only and to allow activation of the cooking device (6) and said cooking hob (7) separately only, wherein the control unit (9) allows activation of the cooking device (6) only in combination with activation of the extractor hood (1).
